(19) United States
(12) Patent Application Publication
(10) Pub. No.: US 2008/0007868 A1
(43) Pub. Date: Jan. 10, 2008

(54) Magnetic recording medium and magnetic storage apparatus

(75) Inventors: Yasutaka Nishida, Tokyo (JP); Masafumi Mochizuki, Kanagawa-ken (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/825,254

(22) Filed: Jul. 3, 2007

(30) Foreign Application Priority Data
Jul. 4, 2006 (JP) 2006-184799

(51) Int. Cl. G11B 5/74

(52) U.S. Cl. 360/131

(57) ABSTRACT

Embodiments of the present invention provide a perpendicular magnetic recording medium capable of suppressing a magnetic field intensity applied to adjacent tracks on a patterned perpendicular recording medium. According to one embodiment of the present invention, unevenly formed soft under layers are stacked on a flat nonmagnetic substrate, thereby the saturation magnetic flux density of the protruded region is set lower than that of the flat region.

### CROSS-REFERENCE TO RELATED APPLICATION

The instant nonprovisional patent application claims priority to Japanese Patent Application No. 2006-184799 filed Jul. 4, 2006 and incorporated by reference in its entirety herein for all purposes.

### BACKGROUND OF THE INVENTION

A magnetic storage apparatus has a magnetic recording medium and a magnetic head and the magnetic head reads and writes data from and on the recording medium. In order to increase the recording capacity per unit area of the magnetic recording medium, the plane recording density is required to be raised. However, when a bit length to be recorded is reduced, a problem arises as it becomes difficult to raise the plane recording density due to thermal fluctuation. Generally, such thermal fluctuation depends significantly on the Ku.V/kT value (Ku: magnetic anisotropy constant, V: magnetization minimum unit cubic volume, k: Boltzmann constant, and T: absolute temperature); the smaller the Ku.V/kT value is, the more the thermal fluctuation advances. Consequently, in order to reduce the thermal fluctuation, the Ku or B is increased. And to solve this problem, a perpendicular recording method is proposed. The method records magnetization signals perpendicularly on an object two-layer perpendicular medium having a soft under layer (SUL) with use of a single magnetic pole head. Using this method enables a stronger recording magnetic field to be applied to the medium. And this makes it possible to use a recording layer of the recording medium having a larger magnetic anisotropy constant (Ku). In the case of the magnetic recording medium of the perpendicular magnetic recording method has a merit that the V value can be increased by letting the magnetic gains grow in a film thickness direction while the grain diameters on the medium surface are kept as is, that is, while the bit length is kept as is. However, as the recording density of the magnetic recording media increases more in the future, it is expected that the resistance to the thermal fluctuation will meet its limit even in the case of the perpendicular magnetic recording method.

As another form of a recording medium suitable for a high recording density, there is a well-known method that makes magnetic grains isolated magnetically from each another to be arrayed regularly and records data by making one grain correspond to one bit, the so-called patterned medium. This method does not generate any noise otherwise to be generated by disturbed magnetization state in a bit transition area, and can reduce the thermal fluctuation by one bit up to its limit. Thus the method is considered to be advantageous for the high density magnetic recording. Similarly, there is a discrete track medium that isolates only each track from others magnetically. In all of those methods, it is characterized that the size of the recording bits in the cross-track direction is determined by the protruded parts of the subject medium.

FIG. 18 shows a relationship between a perpendicular recording magnetic head 14 and a magnetic disk 11, as well as a schematic diagram of the perpendicular recording. A conventional magnetic head has a lower shield 8, a read sensor 7, an upper shield 9, an auxiliary pole, a thin film coil 2, a main pole 1 that are stacked sequentially from the head moving direction side (leading side). The lower shield 8, the read sensor 7, and the upper shield 9 are combined to form a read head 24 while the auxiliary pole 3, the thin film coil 2, and the main pole 1 are combined to form a write head (single pole head) 25. The main pole 1 consists of a main pole yoke 1A connected to the auxiliary pole 3 through a pillar 17 and a pole chip 1B exposed to an air bearing surface and determining the track width. A magnetic field generated from the main pole 1 of the write head 25 passes the magnetic recording layer 19 and the soft under layer 21 of the magnetic disk medium 11 and enters the auxiliary pole 3 to form a magnetic circuit and records a magnetization pattern on the magnetic recording layer 19. In some cases, an intermediate layer is formed between the magnetic recording layer 19 and the soft under layer 21. The soft under layer 21 is formed on the nonmagnetic substrate 22. As the read sensor 7 of the read head 24, a giant magnetoresistive (GMR) element, a tunneling magnetoresistive (TMR) element, or the like is used. The air bearing surface of the main pole 1 should preferably be shaped like a pedestal that is narrow at the leading side by taking into consideration a case in which the head has a skew angle.

The head structure shown in FIG. 18 has a demerit that the existence of the auxiliary pole 3 and the thin film coil 2 between the read sensor 7 and the main pole 1 causes the distance between the write element and the read element to increase, thereby degrading the formatting efficiency. This is why an attempt is made to adopt a structure in which the auxiliary pole 3 is disposed at the trailing side of the main pole 1. This structure can reduce the distance between the write element and the read element.

In addition to the intensity of the write head magnetic field, it is also important to realize a high recording density to obtain gradients of the head magnetic field for recording each transition between recording bit cells, that is, magnetic field gradients of the head magnetic field in the downtrack direction. In order to achieve a higher recording density in the future, the magnetic field gradients will be required to be increased more. And in order to improve the recording magnetic field gradients, a magnetic material is disposed at the trailing side of the main pole 1 in a structure. Furthermore, in another structure, such a magnetic material is also disposed at a side of the main pole 1. Even in this structure, the auxiliary pole for forming a closed flux is disposed at the trailing side of the main pole in some cases.

In the case of any of the patterned media and the discrete track media, the magnetic recording layer, the soft under layer, or the substrate has an uneven surface. Those media are disclosed in, for example, Japanese Patent Publication No. 2004-259306 (“patent document 1”) and Japanese Patent Publication No. 2004-164492 (“patent document 2”). In some cases, the substrate surface is flat and the surfaces of the soft under layer and the magnetic recording layer formed on the substrate are formed unevenly. In other cases, the surface of only the magnetic recording layer is formed unevenly.

In the case of a method that uses the patterned medium or the discrete track medium having an uneven surface, the size of the bits to be recorded in the cross-track direction is determined by the protruded regions of the recording layer. However, also in this case, it is required to eliminate attenuation and erasure of magnetization information recorded in adjacent tracks by reducing the magnetic field intensity applied to the track adjacent to the target track on which data is to be written similarly to any of the above conventional methods. In the case of a method that uses a write head in which a magnetic material is disposed at the trailing side and at the side of the main pole, respectively, the trailing side magnetic field gradients can be increased to suppress the distribution in the cross-track direction, but the magnetic field intensity is decreased. This is a demerit of the method.

As described above, it may be important to apply a high magnetic field intensity to the target track to realize a high recording density without reducing the recording track width and without attenuating/erasing data on adjacent tracks on the medium. This problem must be solved to realize such a higher recording density of each magnetic disk drive that uses the perpendicular magnetic recording method. Particularly, when the surface of the soft under layer is formed unevenly, a magnetic flux is concentrated at the edges of the adjacent tracks, thereby the magnetic field intensity comes to increase.

### BRIEF SUMMARY OF THE INVENTION

Embodiments of the present invention provide a perpendicular magnetic recording medium capable of suppressing a magnetic field intensity applied to adjacent tracks on a patterned perpendicular recording medium. According to one embodiment of present invention, unevenly formed soft under layers are stacked on a flat nonmagnetic substrate, thereby the saturation magnetic flux density of the protruded region is set lower than that of the flat region.

### BRIEF DESCRIPTION OF THE DRAWINGS

FIGS. 1(a) and 1(b) are schematic diagrams of a magnetic recording system;

FIG. 2 is a cross sectional explanatory diagram for showing an example of a magnetic recording medium according to embodiments of the present invention;

FIG. 3 is a top explanatory diagram of a positional relationship between the magnetic recording medium according to embodiments of the present invention and its magnetic head viewed from the trailing direction;

FIG. 4 is a cross sectional explanatory diagram of a positional relationship between the magnetic recording medium according to embodiments of the present invention and its magnetic head viewed from the trailing direction;

FIG. 5 is a diagram for making a comparison between embodiments of the present invention and a comparison example about the distribution of a recording magnetic field in the cross-track direction;

FIGS. 6(a) and 6(b) are concept diagrams for showing a magnetic flux flow according to embodiments of the present invention and that in the comparison example;

FIG. 7 is another diagram for making a comparison between embodiments of the present invention and a comparison example about the distribution of a recording magnetic field in the cross-track direction;

FIG. 8 is a diagram for showing the distribution of a magnetic field intensity in a case where the size of a protruded region soft under layer is changed;

FIG. 9 is a diagram for showing a relationship between a ratio of saturation magnetic flux density between a protruded region soft under layer and a flat region soft under layer and a ratio of magnetic field intensity between adjacent tracks;

FIG. 10 is a diagram for showing a relationship between the film thickness of both protruded and flat regions of a soft under layer and a ratio of magnetic field intensity between adjacent tracks;

FIG. 11 is a cross sectional explanatory diagram for showing an example of the magnetic recording medium according to embodiments of the present invention;

FIG. 12 is another cross sectional explanatory diagram for showing the example of the magnetic recording medium according to embodiments of the present invention;

FIG. 13 is still another cross sectional explanatory diagram for showing the example of the magnetic recording medium according to embodiments of the present invention;

FIGS. 14(a) and 14(b) are schematic perspective views of a discrete track medium and a patterned medium;

FIG. 15 is a concept explanatory diagram of a patterned medium in the downtrack direction, to which embodiments of the present invention applies;

FIGS. 16(a)-16(d) show a cross section process diagram for describing an example of a manufacturing process of the magnetic recording medium according to embodiments of the present invention;

FIGS. 17(a)-17(d) show another cross section process diagram for describing the example of the manufacturing process of the magnetic recording medium according to embodiments of the present invention; and

FIG. 18 is a concept diagram of perpendicular recording.

### DETAILED DESCRIPTION OF THE INVENTION

Embodiments in accordance with the present invention relate to a perpendicular magnetic recording medium and a magnetic storage apparatus that uses the recording medium.

An object of embodiments in accordance with the present invention is to provide a perpendicular recording discrete track medium, a patterned medium, and a magnetic disk drive that can incorporate any of those media, which are all capable of realizing a high density without arising a problem that a recording current flows into a coil of the write head, thereby a recording magnetic field generated from the main pole excited by a recording current leaks to the adjacent tracks to cause the data to be attenuated and erased from those adjacent tracks. Although a method that can take measures for preventing the erasure of data from a target track by means of a floating (external) magnetic field is disclosed in Japanese Laid-Open Patent No. 1994-119632 (“patent document 3”) etc., embodiments of the present invention aim at reducing the influence of the recording magnetic field generated from the main pole excited by the recording current to be exerted on adjacent tracks.

The magnetic recording medium according to embodiments of the present invention has a soft under layer and a magnetic recording layer formed on a flat nonmagnetic substrate, respectively and the soft under layer has protruded regions for forming recording tracks, as well as recessed regions, each of which is provided between tracks. The soft under layer consists of two materials used differently for flat regions and protruded regions and the saturation magnetic flux density of the material used for the protruded regions is set lower than that of the material used for the recessed regions.

In other words, the magnetic recording medium according to embodiments of the present invention comprises a substrate, a soft magnetic layer formed on the substrate, and a magnetic recording layer formed on the soft magnetic layer and the soft magnetic layer consists of a flat-layered first soft magnetic layer and a protruded second soft magnetic layer formed along a track on the first soft magnetic layer. The saturation magnetic flux density of the first soft magnetic layer is higher than that of the second soft magnetic layer and the first and second soft magnetic layer are combined to form a magnetic circuit that returns a magnetic flux concentrated on the second soft magnetic layer to the magnetic head from the write head through the first soft magnetic layer. The saturation magnetic flux density of the second soft magnetic layer should preferably be 0.75 or under the sum of the thickness of the films of the first and second soft magnetic layer. And the ratio of the second soft magnetic layer to the sum of the first and second soft magnetic layers should preferably be within a range of 0.25 to 0.5 and a total thickness of the films of the first and second soft magnetic layer should preferably be 200 nm or under. The medium according to embodiments of the present invention may also be a medium having a plurality of protruded regions formed separately from each another in the track direction on the second soft magnetic layer, that is, a patterned medium.

The magnetic storage apparatus according to embodiments of the present invention incorporates the magnetic recording medium described above. Its magnetic head has a main pole having a tip for determining a track width, an auxiliary pole, a coil interlinking with a magnetic circuit formed with the main pole and the auxiliary pole, and magnetic materials provided at the trailing side and at the cross-track direction side of the main pole, respectively. The distance between the main pole and the auxiliary pole in the cross-track direction should be shorter than that between the protruded second soft magnetic layers adjacent in the track direction of the medium.

According to embodiments of the present invention, therefore, it is possible to provide a perpendicularly recording medium capable of reducing the magnetic field intensity to be applied to adjacent tracks and a magnetic disk drive that incorporates the magnetic recording medium.

Hereunder, an embodiment of the present invention will be described with reference to the accompanying drawings. In those drawings, the same reference numerals will represent the same functional components.

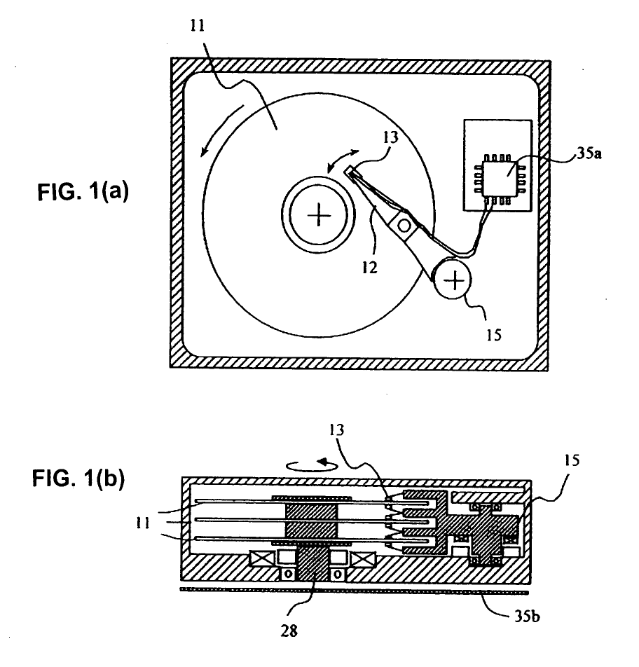

FIG. 1 shows a concept diagram of a magnetic storage apparatus. The magnetic storage apparatus writes and reads magnetization signals with use of a magnetic head provided at a slider 13 fixed to a tip of a suspension arm 12 at a predetermined position on a magnetic disk (magnetic recording medium) 11 rotated by a motor 28. By driving a rotary actuator 15, the magnetic head can be positioned (on a track) on the magnetic disk in the radial direction. Write and read signals to/from the magnetic head are processed in signal processing circuits 35a and 35b.

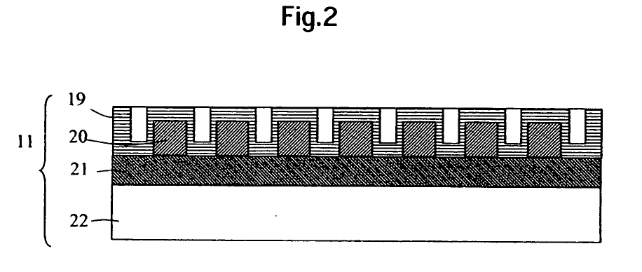

FIG. 2 shows a cross sectional explanatory diagram for an example of a recording medium of the present invention. This magnetic recording medium 11 has soft under layers 20 and 21 having protruded and recessed patterns respectively formed on a nonmagnetic substrate 22 made of flat glass, aluminum alloy, etc. And the saturation magnetic flux density of the soft under layer 20 closer to the write head is lower than that of the soft under layer 21 closer to the substrate. In this embodiment, the saturation magnetic flux density of the protruded soft under layer 20 is set lower than that of the flat soft under layer 21.

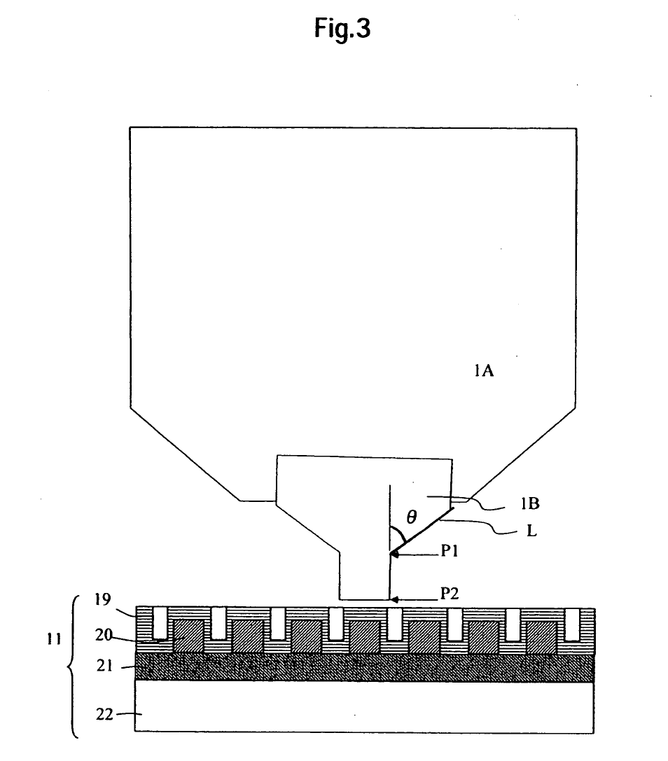

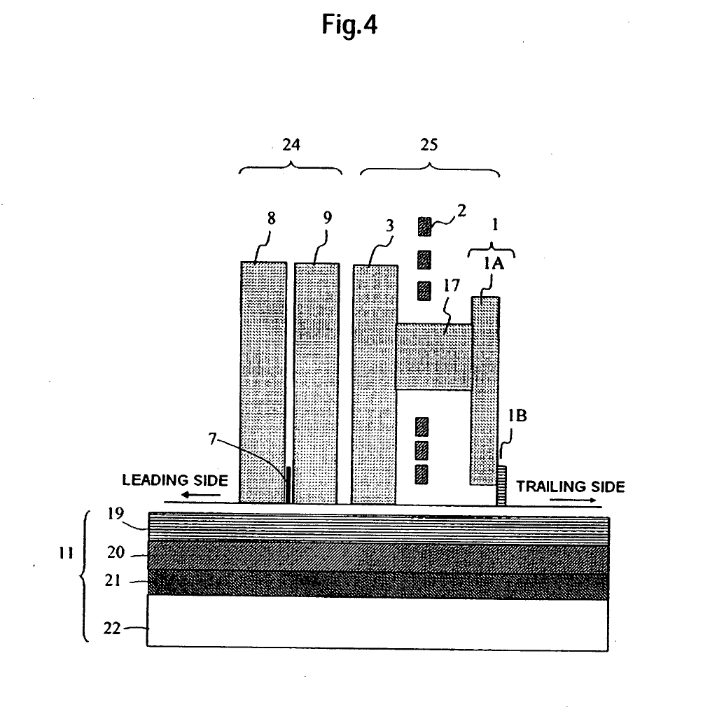

A calculation was made for the recording magnetic field distribution with respect to the magnetic recording medium shown in FIG. 2. The conditions of the calculation are as shown in FIGS. 3 and 4. FIG. 3 shows a top explanatory diagram of a positional relationship between the magnetic recording medium and the magnetic head, viewed from the trailing direction. FIG. 4 shows a cross sectional explanatory diagram of a positional relationship between the magnetic recording medium and the magnetic head. A pole chip 1B that determines a track width of the main pole of the magnetic head was assumed as 80 nm in width and 200 nm in pole thickness. The shape of the air bearing surface was assumed as a trapezoid becoming narrower at the leading side. The length (throat height) from the air bearing surface to a concentrating position was set at 50 nm. The concentrating position mentioned above means a region having a function for enabling the rate of the width in the cross-track direction to change and a magnetic flux to be concentrated in the pole chip 1B. In FIG. 3, the concentrating position is assumed at a point of interpolation of a side L of a slope of the pole chip 1B and a perpendicular line extended from an end part of the air bearing surface of the pole chip 1B in the sensor height direction and the distance between the concentrating position P1 and the end part P2 of the air bearing surface of the pole chip 1B is the throat height. In the schematic structure diagram viewed from the trailing side in FIG. 3, the spreading angle θ of the width of the pole chip 1B from the concentrating position P1 was assumed to be 45 degrees at both right and left sides.

CoNiFe was assumed as the material of the pole chip 1B and the saturation magnetic flux density was set at 2.4 T and the specific permeability was set at 500. A material of 80at80%Ni-20at%Fe of which saturation magnetic flux density was 1.0 T was assumed for the yoke 1A of the main pole. The auxiliary pole 3 was assumed to be made with a material of which saturation magnetic flux density was 1.0 T and its size was assumed to be 30 μm in width in the cross-track direction, 16 μm in length in the sensor height direction, and 2 μm in thickness. The material of the upper and lower shields 9 and 8 was assumed to be 80at%No-20at%Fe of which saturation magnetic flux density was 1.0 T and its size was assumed to be 32 μm in width in the cross-track direction, 16 μm in length in the sensor height direction, and 1.5 μm in film thickness.

It was also assumed to be 1.35 T for the saturation magnetic flux density of the material of the flat region soft under layer 21 of the magnetic recording medium and 0.5 T for the saturation magnetic flux density of the material of the protruded region soft under layer 20. The protruded region soft under layer 20 was set at 50 nm in thickness and 50 nm in width, and 50 nm in distance from others. The recording magnetic field was calculated at a position assumed to be the center of the magnetic recording layer 15 nm away from the head air bearing surface. The medium recording layer 19 was examined only for 22 nm in film thickness.

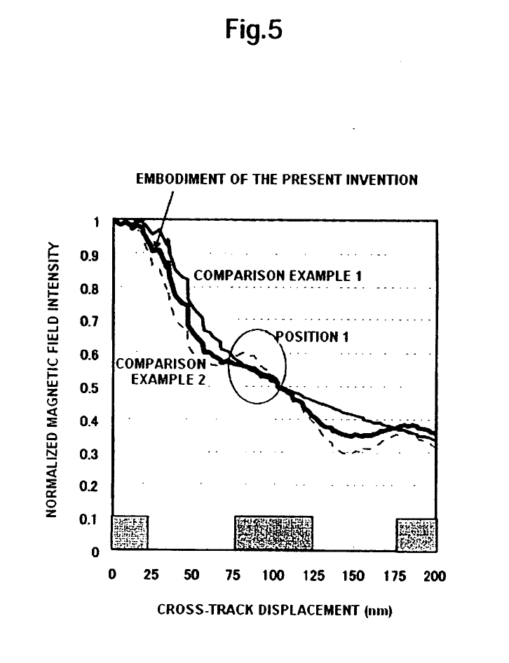

FIG. 5 shows a diagram for comparing the recording magnetic field distribution in the cross-track direction between the medium according to embodiments of the present invention and a conventional structure medium. The horizontal axis in FIG. 5 denotes a distance in the cross-track direction and the vertical axis denotes an intensity of the normalized recording magnetic field. The zero point of the horizontal axis is the center point of a subject track. FIG. 5 also shows results of calculation for both a case in which the soft under layer is flat (example 1) and for another case in which the surface of the soft under layer is uneven and the saturation magnetic flux density of the protruded regions is equal to that of the flat regions of the soft under layer (example 2). In a case where the surface of a soft under layer is uneven, it is understood in FIG. 5 that the magnetic flux is concentrated at the edge of each adjacent track, thereby increasing the magnetic field. On an adjacent track at position 1 enclosed in a circle, the magnetic field intensity increases more in the example 2 than the example 1 in which the soft under layer is flat. And when the intensity increases, data on adjacent tracks is erased. This is a problem for realizing a high recording density. Therefore, the magnetic field intensity on each adjacent track should preferably be at least equal to that in the current example in which the soft under layer is flat. In the embodiment of the present invention shown with a thick line, the saturation magnetic flux density of the soft under layer closer to the head is set lower, so that it will be understood that the rate of the magnetic field applied to each adjacent track can be reduced more than the example 2. Consequently, it is possible to suppress attenuation and erasure of data recorded on those adjacent tracks.

The patent documents 1 and 2 or Japanese Patent Publication No. 2005-302204 discloses a method for changing the saturation magnetic flux density between the soft under layers. According to those methods, the saturation magnetic flux density of the soft under layer closer to the recording layer is set higher and it cannot obtain the same effect as that afforded by embodiments of the present invention. This is because a magnetic flux is apt to flow to adjacent tracks when the saturation magnetic flux density of the layer closer to the recording layer is higher.

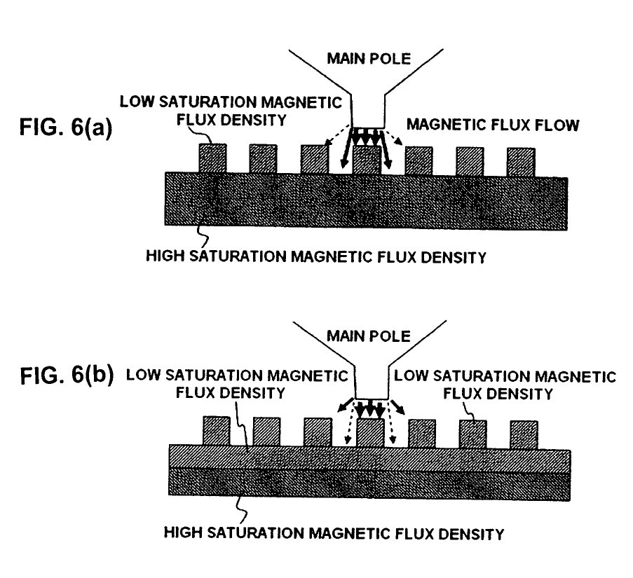

Embodiments of the present invention are characterized in that the saturation magnetic flux density is changed between flat regions and protruded regions of the subject soft under layer. Here, a comparison was made for the recording magnetic field distribution in the cross-track direction with respect to two types of media shown in the cross sectional explanatory diagram in FIG. 6. FIG. 6(a) corresponds to the medium according an embodiment of the present invention shown in FIG. 2 and FIG. 6(b) corresponds to the medium in example 3 in which the flat region soft under layer consists of two layers and the saturation magnetic flux density of the soft magnetic layer at the surface side of each flat region is the same as that of the protruded regions and the saturation magnetic flux density of only the flat region soft magnetic layer farther from the write head is set higher. The saturation magnetic flux density was set at 0.5 T for the material having a low saturation magnetic flux density and 1.35 T for the material having a high saturation magnetic flux density. The height of the protruded regions was set at 50 nm.

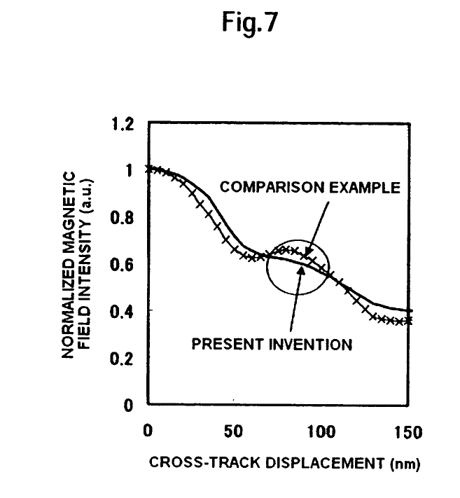

FIG. 7 shows a result of the calculation. The magnetic field intensity at each adjacent track position denoted by a circle is more reduced in the case of embodiments of the present invention. This is because the difference in the extents of magnetic flowing easily to adjacent tracks and flat regions depends mainly on distance in the case of the comparison example 3 in which the saturation magnetic flux density is the same between the protruded regions and the flat regions on the surface of the soft magnetic layer as shown in the explanatory diagram of a magnetic flux flow with an arrow in FIG. 6. While, the medium according to embodiments of the present invention can use the effect of the difference in the saturation magnetic flux density of those flat and protruded regions in addition to the above object. Thereby the magnetic field to be applied to adjacent tracks can be reduced.

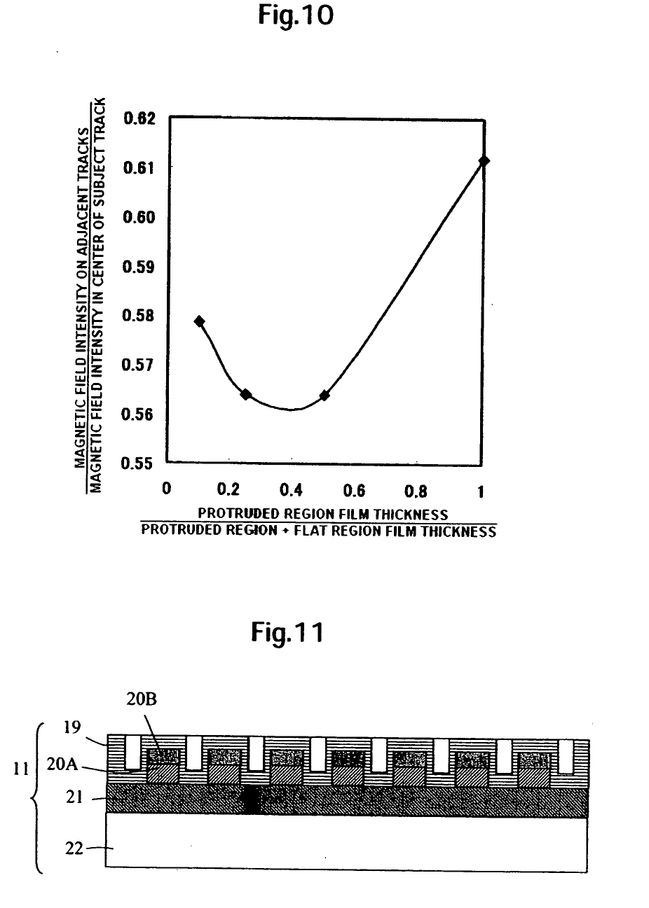

The significant effect afforded by embodiments of the present invention can be obtained, since the saturation magnetic flux density is lower on the protruded region soft under layer closest to the write head than on the flat region soft under layer, that is, the flat region soft under layer has no region at which the saturation magnetic flux density is as low as that of the protruded region soft under layer closest to the write head. If the protruded regions are low in height, the effect afforded by embodiments of the present invention is reduced. To solve this problem, therefore, it would be understood that there is an optimized condition as to be described later with reference to FIG. 10 with respect to the height of the protruded regions and the film thickness of the flat regions.

In the case of one embodiment the present invention, a total of the film thickness of the first and second soft magnetic layers should preferably be 200 nm or under. In case where the surface of a soft under layer is formed unevenly, the flat and protruded regions are required to be combined to form a closed flux for forming a recording magnetic field to obtain the effect of embodiments of the present invention. If the protruded region is enough in film thickness, each flat region goes out of the closed flux for forming a recording magnetic field. Even when the flat region is enough in film thickness, the protruded region is required to be thick enough in film thickness when consideration is taken to a range of the ratio of film thickness between the protruded region and the flat region to obtain the effect of embodiments of the present invention as shown in the comparison in FIG. 10. Consequently, in the case of one embodiment of the present invention, the soft under layer should preferably be thin. However, the thinner the soft under layer becomes, the lower the recording magnetic field intensity becomes. And the soft under layer should preferably be thicker to improve the recording magnetic field intensity. However, even when the film thickness is over 200 nm, the magnetic field intensity cannot be increased so much. From the point of view of the magnetic field intensity, 200 nm or so will be enough. Thus the film thickness of the soft under layer should preferably be 200 nm or under.

Patent document 3 discloses a method for using a 2 to 3 μm soft under layer and a soft magnetic substrate having a higher permeability than that of the soft under layer. This soft magnetic substrate is adopted by taking consideration to data erasure by a floating magnetic field. The substrate is disposed outside a closed flux for forming a recording magnetic field and it does not form a closed flux that returns a magnetic flux from the magnetic head. In the paragraph [0053], it reads that the film thickness of the soft under layer should satisfy a value at which the read output is about to be saturated by taking consideration to a relationship with how much the floating magnetic field is absorbed, so that the film thickness is set at 2 μm or so. If it is assumed that the soft magnetic substrate functions as a soft under layer for returning a magnetic flux from the magnetic head, the magnetic flux from the magnetic head can also be returned from the soft magnetic substrate having a high permeability. Thus the output cannot depend on the film thickness of the soft under layer. While the output depends on the thickness of the substrate, it can hardly depend on the film thickness of the soft under layer. On the other hand, FIG. 7 of Patent document 3 shows the dependency of the read output on the film thickness of the soft under layer. It will be understood with reference to FIG. 7 that the output increases in proportion to the thickness of the soft under layer. In other words, a soft magnetic substrate with a thicker film is apparently outside a closed flux.

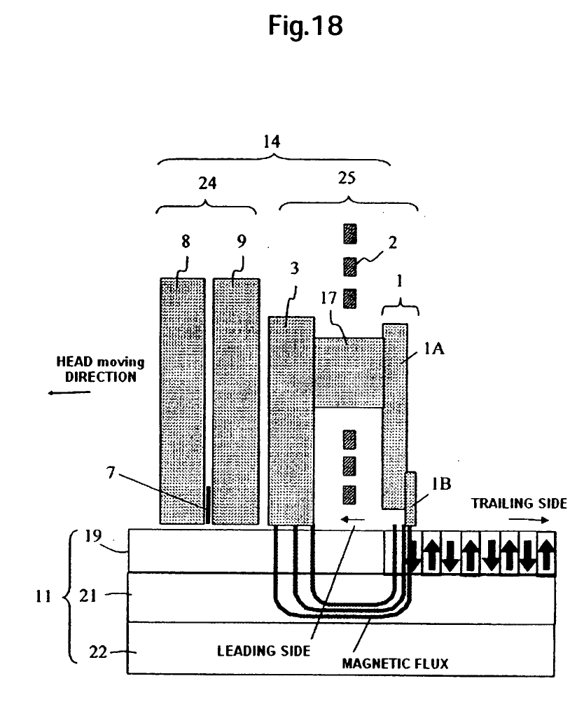

In the case of a two-layer recording medium having a soft under layer, as shown in FIG. 18, the recording magnetic field is formed by a closed flux that passes the recording layer from the tip of the main pole, then passes the soft under layer and the auxiliary pole. The substrate does not form any flux for generating the recording magnetic field. If the soft under layer is thick, the substrate does not form any closed flux that functions to form the recording magnetic field even when the substrate is made of a magnetic material. Thus the lower substrate never affects the recording magnetic field. This is why the method cannot obtain the effect afforded by embodiments of the present invention.

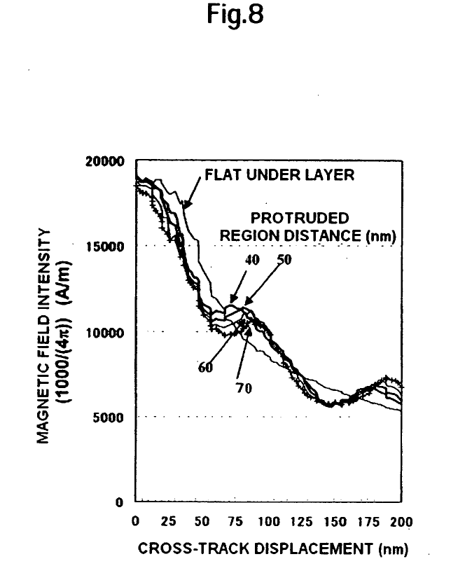

FIG. 8 is a diagram for showing the distribution of a magnetic field intensity in a case where the soft under layer has both protruded and recessed regions and the distance between the protruded regions is changed. The same saturation magnetic flux density of the soft under layer was assumed for both protruded and recessed regions. Other conditions of the calculation are the same as those of the examination shown in FIG. 5. In this case, the position of the magnetic field intensity peak on adjacent tracks moves, but the intensity cannot be reduced so much when compared with a case in which the soft under layer is flat. As shown in FIG. 5, in order to reduce the magnetic field intensity on adjacent tracks, the structure according to embodiments of the present invention is effective. In the structure, the saturation magnetic flux density of the protruded region soft magnetic layer 20 is lower than that of the flat region soft magnetic layer 21.

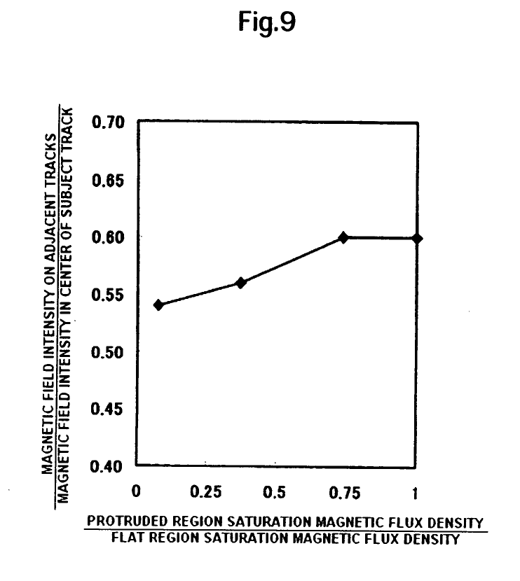

FIG. 9 is a diagram for showing a case in which the ratio of the flat region saturation magnetic flux density to that at the protruded region soft magnetic layer is changed to check how the rate of the magnetic field applied to those adjacent tracks is changed. The conditions of the calculation other than the magnetic flux density are the same as those in the examination shown in FIG. 5. The horizontal axis denotes a rate between the saturation magnetic flux density at protruded regions and that at the flat regions and the vertical axis denotes a magnetic field intensity applied to adjacent tracks normalized with the magnetic intensity in the center of the subject track. In a case where the ratio between the protruded regions and the flat regions of the subject soft under layer is 0.75 or over, the rate of the magnetic field intensity applied to the adjacent tracks does not change. Thus the ratio between the saturation magnetic flux density in the protruded regions and that in the flat regions of the subject soft under layer should preferably be under 0.75 to obtain the effect afforded by embodiments of the present invention.

FIG. 10 is a diagram for showing how the rate of the magnetic field applied to adjacent tracks is changed when the film thickness differs between the protruded regions and the flat regions of the soft under layer. The vertical axis denotes a ratio of the magnetic field intensity between the center of the subject track and each adjacent track and the horizontal axis denotes a ratio of the film thickness between each protruded region and the whole under layer (sum of the film thickness of both protruded and flat regions). The saturation magnetic flux density was set at 0.5 T for the protruded regions and 1.35 T and for the flat regions respectively. When the protruded regions are thin in film thickness (when the value of the horizontal axis is small), the ratio denoted by the vertical axis is large, so that it is understood that the effect is low. This is because a magnetic flux leaks excessively into adjacent tracks. When the film of the protruded regions is thick (when the value denoted by the horizontal axis is large), the ratio denoted by the vertical axis is large, so that it is understood that the effect is low. This is because the flux flow to the subject track is reduced. In order to obtain the effect afforded by embodiments of the present invention, therefore, the ratio of the film thickness between each protruded region and the whole under layer (sum of the film thickness of both protruded and flat regions) should preferably be around from 0.25 to 0.5.

FIG. 11 is a cross sectional explanatory diagram for showing another embodiment of the magnetic recording medium of the present invention. This medium has a flat soft under layer 21 and a soft under layer for forming protruded regions instead of the uneven soft under layers 20 and 21 formed on a flat nonmagnetic substrate 22 and the soft under layer for forming the protruded regions consists of two soft under layers 20A and 20B. Here, the soft under layer for forming the protruded regions is formed so that the saturation magnetic flux density of the protruded region soft under layer 20B closer to the write head is lower than that of the soft under layer 20A closer to the flat soft under layer 21. This structure makes it possible to reduce the concentration of the magnetic flux on the edge of each protruded region of adjacent tracks, thereby the magnetic field applied to the adjacent tracks can be suppressed. The saturation magnetic flux density of the soft under layer 20B should preferably be lower than that of the layer 20A.

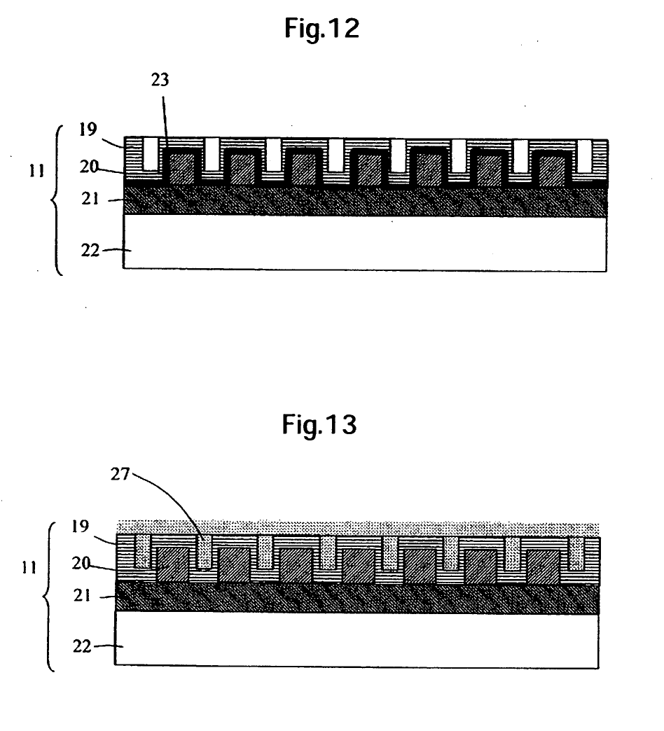

Furthermore, in the case of the magnetic recording medium according to an embodiment of the present invention, as shown in FIG. 12, a nonmagnetic intermediate layer 23 may be formed between the recording layer 19 and each of the soft under layers 20 and 21. The material of the nonmagnetic intermediate layer 23 may be any of such oxides as Ta, Cu, SiO, Al₂O₃, TiO₂, etc. and such carbides as Si₃N₄, AlN, TiN, etc. This intermediate layer can change the characteristic of the recording magnetic film. And changing the film thickness makes it possible to make such adjustments as increasing the magnetic field intensity and the magnetic field gradients. And as shown in FIG. 13, the magnetic recording medium according to an embodiment of the present invention enables a nonmagnetic film 27 to be formed in each recessed region of the recording layer and the surface of the medium to be flat as needed. Furthermore, in the case of each of the media shown in FIGS. 2 and 11-13, a protection film should preferably be formed on the recording layer 19 or nonmagnetic film 27. A nonmagnetic layer may also be formed between the flat region soft under layer 21 and the protruded region soft under layer 20. The nonmagnetic layer material may be any of such oxides as Ta, Cu, SiO₂, Al₂O₃, TiO₂, etc. and such carbides as Si₃N₄, AlN, TiN, etc.

Among the materials of the soft under layer, FeCo family, FeCoB, FeCoV, FeSi, FeSiB—C, etc. are materials having a higher saturation magnetic flux density. And CoTaZr, CoZrNb, FeNi, FeCr, NiFeO, AlFeSi, NiTaZr, etc. are materials having lower saturation magnetic flux density. As the materials of the recording layer 19, there are granular films such as CoCrPt—SiO₂, etc. a FePt ordered alloy, a Co/Pd, Co/Pt artificial grid film, a TbFeCo amorphous film, etc.

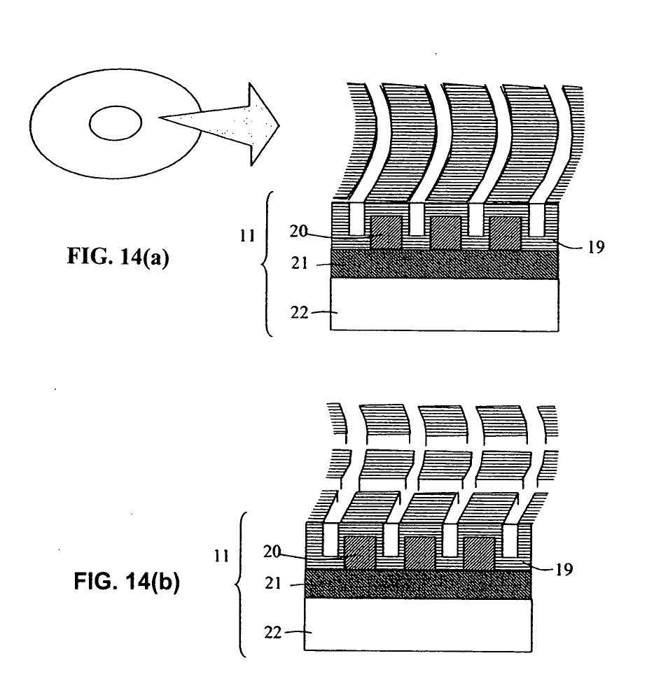

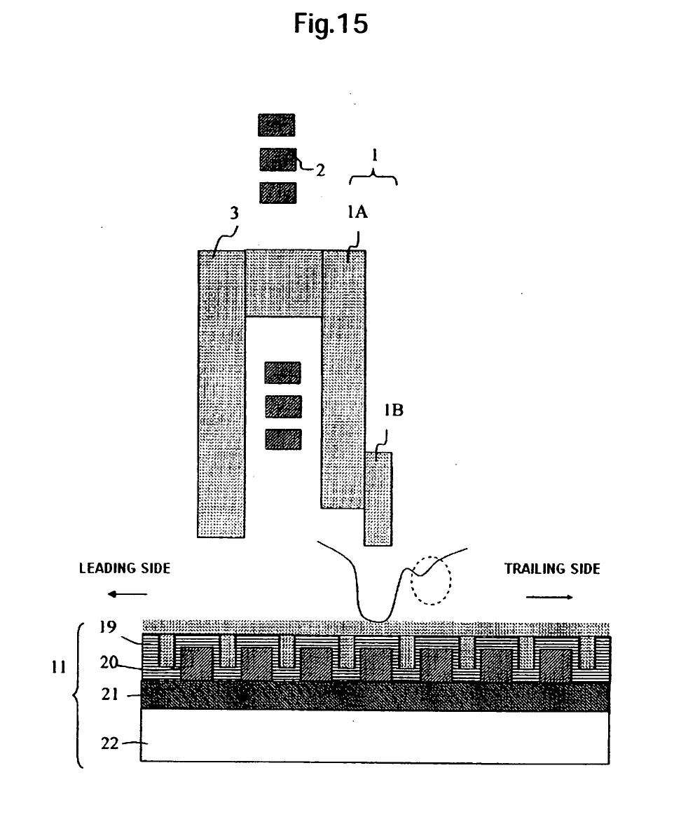

The configuration according to embodiments of the present invention is effective for any of the discrete track medium shown in FIG. 14(a) and the patterned medium shown in FIG. 14(b). Particularly, when embodiments of the present invention are applied to the patterned medium, it is possible to suppress the magnetic field applied to the recorded bits at the trailing side of the same track according to the same principle as that of the cross-track direction as shown in the concept diagram in FIG. 15.

In another embodiment of the magnetic recording medium of the present invention, it is also possible to form soft under layers having protruded and recessed patterns 20 and 21 on a flat nonmagnetic substrate 22 and set the specific permeability of the protruded region soft under layer 20 lower than that of the flat region soft under layer 21. In the structure shown in FIG. 11, it is also possible to set the specific permeability of the protruded region soft under layer 20B closer to the write head lower than that of the protruded region soft under layer 20A closer to the flat soft under layer 21. This configuration can reduce the concentration of the magnetic flux on the edge of each protruded region of adjacent tracks and suppress the magnetic field applied to those adjacent tracks.

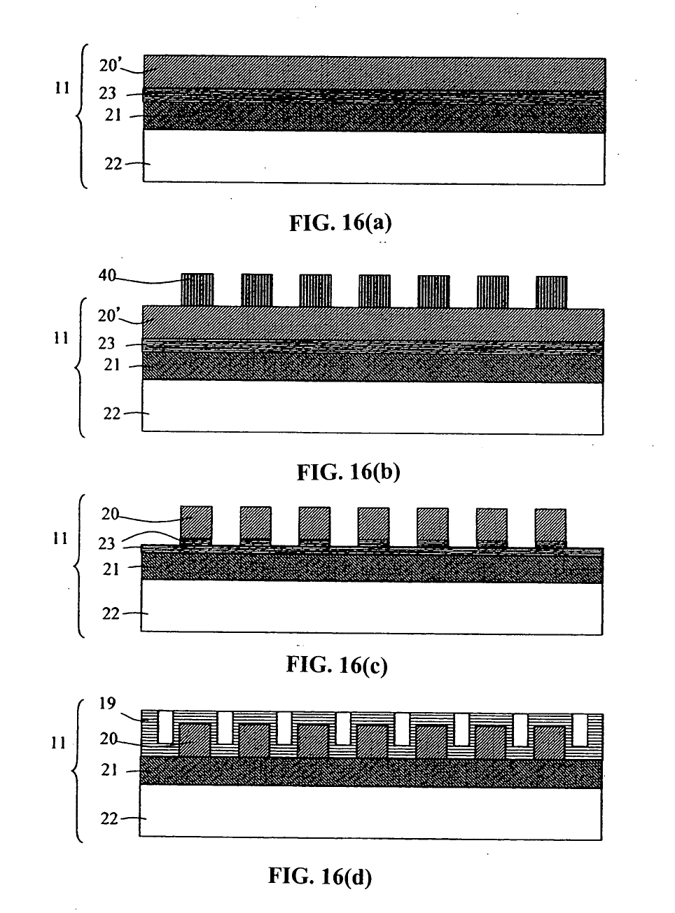

FIG. 16 is a cross sectional diagram for describing an example of manufacturing processes of the magnetic recording medium of the present invention. At first, as shown in FIG. 16(a), on a substrate 22 are deposited consecutively a flat region soft under layer 21, a separation layer 23, and a magnetic film 20′ equivalent to a protruded region soft under layer 20. The film thickness of each layer is determined as several tens of nm, several nm, around several tens of nm, for example, 40 nm, 5 nm, and 20 nm respectively. This magnetic film 20′ is required to satisfy the characteristic of the protruded region soft under layer 20, so that a ferromagnetic material having a smaller saturation magnetic flux density Bs than that of the flat region soft under layer 21 is used. Then, as shown in FIG. 16(b), a masking pattern 40 is formed for etching the magnetic film 20′. This masking pattern 40 may be formed with any of single resin such as a photo-resist material, a multilayer consisting of resin and metal or resin and an oxide (Al—O, Si—O, etc.) to improve the etching accuracy. To form the masking pattern 40, the resist resin is patterned by irradiating an ultraviolet laser beam, an electron beam, or an X-ray or by molding and curing the resin with a heat or ultraviolet beam with use of a nano-in-printing method.

After that, as shown in FIG. 16(c), the magnetic film 20′ is etched to form the protruded region soft magnetic layer 20. This etching can use an ion milling method that uses Ar ions, etc., as well as a so-called reactive ion etching method that can carry out chemical etching and physical etching in parallel simultaneously using an active gas. In any of the above etching methods, a separation layer 23 is usually required to determine an ending point before beginning etching on the flat region soft magnetic layer 21. In many cases, etching is also done on this separation layer 23. This is understood in FIG. 16(c), since protruded and recessed regions are formed on the surface of this separation layer 23. However, in case where the composition differs clearly between the protruded region soft magnetic layer 20 and the flat region magnetic layer 21, etching is hardly done on the flat region magnetic layer 21. Thus the separation layer 23 can be omitted. Finally, as shown in FIG. 16(d), the recording layer 19 is deposited with CoCrPt—SiO₂ at a thickness of several tens of nm.

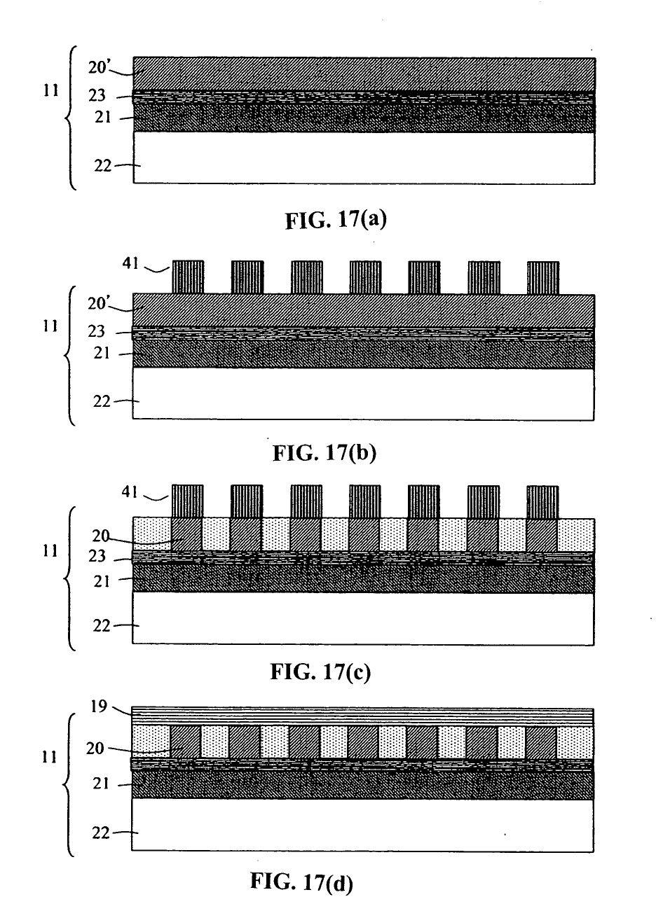

FIG. 17 is a cross sectional process diagram for describing another example of manufacturing processes of the magnetic recording medium according to an embodiment of the present invention. In FIG. 17, an ion implantation method is used instead of etching for patterning substantially to form the protruded region soft magnetic layer 20. This is a main difference from the manufacturing processes shown in FIG. 16. The ion implantation method means a method for accelerating ions as an additive element with an electric field of several hundreds of kV to implant the ions into the object material, thereby controlling the composition/characteristic of the material. Plasma doping, laser doping, etc. are similar methods of this ion implantation method. In any way, a so-called impurity doping method may be used here as needed in semiconductor element processes. Those methods can change the characteristic of an object material partially by implanting ions only in a selected region by covering other regions with a masking pattern using resist or another material beforehand.

As an element to be added to an ferromagnetic material, any of N, Ga, Ar, Cr, B, etc. that do not ferromagnetism can be used. Rare earth elements may also be used. Next, a description will be made for the second concrete manufacturing steps with reference to FIG. 17.

At first, as shown in FIG. 17(a), a flat region soft magnetic layer 21, a separation layer 23, then a magnetic film 20′ that is equivalent to a protruded region magnetic layer 20 are deposited consecutively on a substrate 22. The film thickness of each layer was determined as several tens of nm, several nm, and about several tens of nm, for example, 40 nm, 5 nm, and 20 nm, respectively. After that, as shown in FIG. 17(b), a masking pattern 41 is formed. At this time, unlike the case shown in FIG. 16(b), the masking pattern should preferably cover each region that requires no protruded region magnetic layer 20. Then, as shown in FIG. 17(c), ions as an additional element are implanted all over the substrate. Consequently, each region not covered with the masking pattern 41 comes to be made of a material having a very weak magnetism, thereby substantially realizing the same configuration as that in the etched regions in the manufacturing process shown in FIG. 16. Finally, as shown in FIG. 17(d), a recording layer 19 is deposited with several tens of nm with CoCrPt—SiO₂ or the like.

The magnetic recording medium created in the above manufacturing processes is characterized in that the recording layer can be smoothed in the final process. Thus it is expected that the medium can have stable characteristics even when the head slider floats at a low spacing and suitable for compact disk drives requiring high shock resistance and having a form factor under 2.5 inches, respectively.

Even when any of the above methods is adopted to manufacture the magnetic recording medium according to embodiments of the present invention, the characteristic of the magnetic recording medium has not shown remarkable differences in the evaluation of the reading and writing characteristics after a protection layer is deposited with C, C—N, Si—N, or the like on the surface of the recording layer and a lubrication material is coated on the protection layer.

What is claimed is:

1. A magnetic storage apparatus, comprising:
a magnetic recording medium having a substrate, a soft magnetic layer formed on said substrate, and a magnetic recording layer formed on said soft magnetic layer;
a medium driving part for driving said magnetic recording medium;
a magnetic head consisting of a write head and a read head and used to write and read data on and from said magnetic recording medium; and
a head driving part for positioning said magnetic head with respect to said magnetic recording medium;
wherein said soft magnetic layer has a flat-layered first soft magnetic layer and a convex second soft magnetic layer formed along a track on said first soft magnetic layer;
wherein a saturation magnetic flux density of said first soft magnetic layer is higher than that of said second soft magnetic layer; and
wherein said first and second soft magnetic layers are combined to form a magnetic circuit that returns a magnetic flux concentrated on said second soft magnetic layer from said write head to said magnetic head through said first soft magnetic layer.

2. The magnetic storage apparatus according to claim 1,
wherein said write head has a main pole having a tip part for determining a track width; an auxiliary pole; a coil interlinking with said magnetic circuit formed with said main and auxiliary poles; and a magnetic material provided at a trailing side of said main pole and at a cross-track displacement side, respectively; and
wherein a distance between said main pole and said magnetic material in said cross-track direction is smaller than that between said convex second soft magnetic layers adjacent in a track direction.

3. The magnetic storage apparatus according to claim 1,
wherein said second soft magnetic layer consists of a multilayers and a saturation magnetic flux density of one of said multilayers, closer to said magnetic head, is lower than that of another layer closer to said first soft magnetic layer.

4. The magnetic storage apparatus according to claim 1,
wherein said second soft magnetic layer has a plurality of protruded regions formed separately from each another in a track direction.

5. The magnetic storage apparatus according to claim 1,
wherein a nonmagnetic layer is provided between said soft magnetic layer and said magnetic recording layer.

6. The magnetic storage apparatus according to claim 1,
wherein a nonmagnetic material is embedded between said protruded regions of said second soft magnetic layer.

7. The magnetic storage apparatus according to claim 1,
wherein said saturation magnetic flux density of said second soft magnetic layer is 0.75 or under that of said first soft magnetic layer.

8. The magnetic storage apparatus according to claim 1,
wherein a ratio of a film thickness of said second soft magnetic layer to a sum of film thickness of said first and second soft magnetic layers is within a range of 0.25 to 0.5.

9. The magnetic storage apparatus according to claim 1,
wherein a total film thickness of said first and second soft magnetic layers is 200 nm or under.

10. A magnetic recording medium, comprising:
a substrate; a soft magnetic layer formed on said substrate; and a magnetic recording layer formed on said soft magnetic layer;
wherein said soft magnetic layer has a flat-layered first soft magnetic layer and a convex second soft magnetic layer formed along a track on said first soft magnetic layer, and a saturation magnetic flux density of said first soft magnetic layer is higher than that of said second soft magnetic layer and said first and second soft magnetic layer are combined to form a magnetic circuit that returns a magnetic flux concentrated on said second soft magnetic layer from said write head to said magnetic head through said first soft magnetic layer.

11. The magnetic recording medium according to claim 10,
wherein said second soft magnetic layer consists of a plurality of layers and a saturation magnetic flux density of one of those layers, closer to said magnetic head, is lower than that of another layer closer to said first soft magnetic layer.

12. The magnetic recording medium according to claim 10,
wherein said second soft magnetic layer has a plurality of protruded regions formed separately from each another in a track direction.

13. The magnetic recording medium according to claim 10,
wherein a nonmagnetic layer is provided between said soft magnetic layer and said magnetic recording layer.

14. The magnetic recording medium according to claim 10,
wherein a nonmagnetic material is embedded between said protruded regions of said second soft magnetic layer.

15. The magnetic recording medium according to claim 10,
wherein said saturation magnetic flux density of said second soft magnetic layer is 0.75 or under that of said first soft magnetic layer.

16. The magnetic recording medium according to claim 10,
wherein a ratio of film thickness of said second soft magnetic layer to a sum of film thickness of said first and second soft magnetic layer is within a range of 0.25 to 0.5.

17. The magnetic recording medium according to claim 10,
wherein a total of film thickness of said first and second soft magnetic layers is 200 nm or under.
